(19) United States
(12) Patent Application Publication
(10) Pub. No.: US 2024/0114338 A1
(43) Pub. Date: Apr. 4, 2024

(54) SYSTEMS AND METHODS FOR AUTHENTICATION OF NON-3GPP DEVICES BEHIND A RESIDENTIAL GATEWAY

(71) Applicant: CABLE TELEVISION LABORATORIES, INC, Louisville, CO (US)

(72) Inventor: TAO WAN, Louisville, CO (US)

(21) Appl. No.: 18/480,893

(22) Filed: Oct. 4, 2023

Related U.S. Application Data
(60) Provisional application No. 63/412,992, filed on Oct. 4, 2022.
(60) Provisional application No. 63/444,475, filed on Feb. 9, 2023.
(60) Provisional application No. 63/465,770, filed on May 11, 2023.

(51) Int. Cl. H04W 12/06

(52) U.S. Cl. CPC H04W 12/06

(57) ABSTRACT

A system for authenticating a core network includes a computing device including at least one processor in communication with at least one memory device. The at least one memory device stores a plurality of instructions, which when executed cause the processor to receive an authentication request message routed from a non-3GPP device. The executed instructions also cause the processor to transfer the authentication request message to a unified data management function. The executed instructions further cause the processor to select an authentication method based upon the authentication request. In addition, the executed instructions cause the processor to transmit an authentication challenge message to the non-3GPP device. Moreover, the executed instructions cause the processor to receive the authentication response from the non-3GPP device. Furthermore, the executed instructions cause the processor to verify the authentication response. Additionally, the executed instructions cause the processor to transmit the authentication result to the non-3GPP device.

### CROSS REFERENCE TO RELATED APPLICATIONS

This application claims the benefit of and priority to U.S. Provisional Patent Application No. 63/412,992, filed Oct. 4, 2022, and to U.S. Provisional Patent Application No. 63/444,475, filed Feb. 9, 2023, and to U.S. Provisional Patent Application No. 63/465,770, filed May 11, 2023. The contents and disclosures of all of these prior applications are incorporated by reference in their entireties.

### BACKGROUND

The field of the disclosure relates generally to authentication of non-3GPP devices behind a residential gateway, to systems and methods for authenticating non-3GPP devices on a home network behind a residential gateway with a 5G Call Network or other networks.

Supporting Wireless and Wireline Convergence for 5G systems requires the addition of two new network entities, 5G-RG (5G Residential Gateway) and FN-RG (Fixed Network Residential Gateway). Both of which are introduced in the System architecture for the 5G System (5GS), specifically Technical Specification (TS) 23.501.

The 5G-RG acts as a 5G UE (user equipment) and can connect to a 5G Core Network (5GC) via a wireline access network (W-5GAN—wireless local area network—5G Access Network) or via a Fixed Wireless Access (FWA). The 5G-RG also acts as end point of Ni and provides the NAS (Non-Access Stratum) signaling connection to the 5GC on behalf of non-5G compatible devices (N5GC) and authenticatable non-3GPP devices (AUN3), which can be located behind the 5G-RG. A 5G-capable UE can connect to the 5GC through an RG that's connected to the 5GC via wireline access network (W-5GAN) or a next generation radio access network (NG-RAN). However, it would be desirable to have a system that allows non-5G compatible devices (N5GC) and authenticatable non-3GPP devices (AUN3) behind the 5G-RG to be able to authenticate with the 5GC.

### BRIEF DESCRIPTION

In one aspect, a system for authenticating a core network including a computing device is provided. The computing device includes at least one processor in communication with at least one memory device. The computing device is a part of the core network. The at least one memory device stores a plurality of instructions, which when executed by the at least one processor cause the at least one processor to receive, from a gateway, an authentication request message routed from a non-3GPP device. The executed instructions also cause the processor to transfer the authentication request message to a unified data management function. The executed instructions further cause the processor to select, by the unified data management function, an authentication method based upon the authentication request. In addition, the executed instructions cause the processor to transmit an authentication challenge message to the non-3GPP device. Moreover, the executed instructions cause the processor to receive, from the gateway, the authentication response from the non-3GPP device. Furthermore, the executed instructions cause the processor to verify the authentication response. Additionally, the executed instructions cause the processor to transmit the authentication result to the non-3GPP device.

In another aspect, a server for authenticating a core network is provided. The server includes a transceiver configured for operable communication with at least one gateway external to the core network, and a processor including a memory configured to store computer-executable instructions, which, when executed by the processor, cause the server to receive, from a gateway, an authentication request message routed from a non-3GPP device. The executed instructions also cause the processor to transfer the authentication request message to a unified data management function. The executed instructions further cause the processor to select, by the unified data management function, an authentication method based upon the authentication request. In addition, the executed instructions cause the processor to transmit an authentication challenge message to the non-3GPP device. Moreover, the executed instructions cause the processor to receive, from the gateway, the authentication response from the non-3GPP device. Furthermore, the executed instructions cause the processor to verify the authentication response. Additionally, the executed instructions cause the processor to transmit the authentication result to the non-3GPP device.

### BRIEF DESCRIPTION OF THE DRAWINGS

These and other features, aspects, and advantages of the present disclosure will become better understood when the following detailed description is read with reference to the following accompanying drawings, in which like characters represent like parts throughout the drawings.

FIG. 1 is a schematic illustration of a system for authentication of non-3GPP devices behind a residential gateway.

FIG. 2 is a timing diagram of a process for authentication of non-3GPP devices behind a residential gateway using the system depicted in FIG. 1.

FIG. 3 is a timing diagram of a process for authentication of non-3GPP devices behind a residential gateway using a key generating Extensible Authentication Protocol (EAP) method other than EAP-Authentication and Key Agreement′ using the system depicted in FIG. 1.

FIG. 4 is a timing diagram of a process for authentication of non-3GPP devices behind a residential gateway using the Authentication and Authorization server depicted in FIG. 1.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable and include any computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The field of the disclosure relates generally to authentication of non-3GPP devices behind a residential gateway (RG), to systems and methods for authenticating non-3GPP devices on a home network behind a residential gateway (RG) with a 5G Call Network (N5GC) or other networks.

In some embodiments, the Fixed Network Residential Gateway (FN-RG) can connect to a 5G Core Network (5GC) via a wireline access network (W-5GAN). The W-AGF (WLAN-Access Gateway Function) performs the registration procedure on behalf of the FN-RG and for the non-5G compatible devices (N5GC) and authenticatable non-3GPP devices (AUN3) behind the FN-RG. The W-AGF acts as end point of Ni and provides the Non-Access Stratum (NAS) signaling connection to the 5GC on behalf of the FN-RG. A 5G-capable user equipment (UE) can connect to the 5GC through an RG that's connected to the 5GC via a wireline access network (W-5GAN) or a next generation radio access network (NG-RAN). In these embodiments, the UE supports untrusted non-3GPP access and/or trusted non-3GPP access.

An AUN3 device behind a 5G-RG or a FN-RG can be registered to the 5GC by the 5G-RG or the W-AGF, respectively. As described herein, the AUN3 is authenticated by the 5GC using the Extensible Authentication Protocol Authentication and Key Agreement (EAP-AKA′) as specified in RFC 5448 and as modified as described below.

An AUN3 device behind a Residential Gateways (RG) in a private network or in isolated deployment scenarios (i.e., not roaming) may be authenticated using a key generating EAP method other than EAP-AKA′. An AUN3 device may also be authenticated by 5GC or a Credential Holder using an Authentication and Authorization (AAA) server.

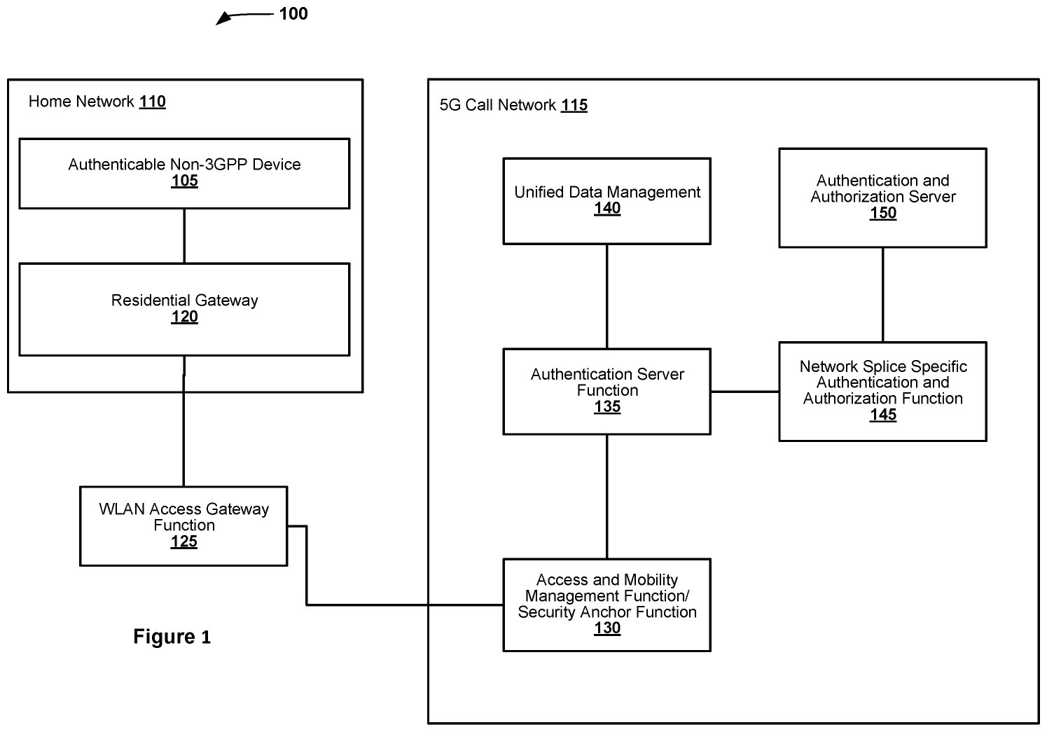

FIG. 1 is a schematic illustration of a system 100 for authentication of non-3GPP devices behind a residential gateway. In an exemplary embodiment, system 100 is configured for monitoring communications from authenticate non-3GPP devices (AUN3) 105 on a home network 110 to a 5G Call Network (5GC) 115. AUN3 105 may, for example include without limitation a desktop computer, a laptop computer, a personal digital assistant (PDA), a cellular phone, a smartphone, a tablet, a phablet, wearable electronics, smart watch, an IP camera, and/or other web-based connectable equipment or mobile devices. In the exemplary embodiment, the home network 110 is considered an Access Network.

In the exemplary embodiment, the AUN3 105 are connected to a residential gateway (RG) 120, such as over a wired connection (e.g., Ethernet), a wireless connection (e.g., Wi-Fi), or an Internet of Things (IoT)-type connection. In some embodiments, the RG 120 is a cable modem. In other embodiments, the RG 120 is another type of device that enables the system 100 to operate as described herein. In some embodiments, AUN3 105 is visible to the 5GC 115. In other embodiments, the AUN3 105 are hidden from the 5GC 115, such as behind the RG 120.

The RG 120 may thus be configured to route data from the AUN3 105 to the WLAN Access Gateway Function (WAGF) 125 associated with the 5GC 115. The WAGF 125 acts as the interface between the home network 110 and the 5GC 115. In the exemplary embodiment, the WAGF 125 converts the messages as they are transmitted between the home network 110 and the 5GC 115. For example, the WAGF 125 receives an Authentication and Authorization (AAA) message from the RG 120 of the home network 110. The WAGF 125 converts the AAA message into a 3G message for transmission to the 5GC 115 and more specifically to the Access and Mobility Management Function/security anchor function (AMF/SEAF) 130 of the 5GC 115. The AMF/SEAF 130 terminates the control plane of different access networks onto the 5G Core Network 115 (5GC) and control which devices can access the 5GC 110.

In the exemplary embodiment, the 5GC 115 includes the AMF/SEAF 130, which is in communication with an Authentication Server Function (AUSF) 135. The AUSF 135 is responsible to handle authentication requests for both, 3GPP access and untrusted non-3GPP access. The AUSF 135 is in communication with a unified data management (UDM) 140. The UDM 140 manages network user data in a centralized element. The AUSF 135 is configured to receive authentication requests and interact with the UDM 140 to obtain authentication vectors for processing 5G AKA authentication and to validate network responses to determine whether or not the authentication was successful.

In some embodiments, the AUSF 135 is also in communication with a Network Slice Specific Authentication and Authorization Function (NSSAAF) 145 that supports Network Slice-Specific Authentication and Authorization with a AAA Server (Authentication and Authorization) 150. If the AAA Server 150 belongs to a third party, the NSSAAF 145 may contact the AAA Server 150 via a AAA proxy (AAA-P) (not shown).

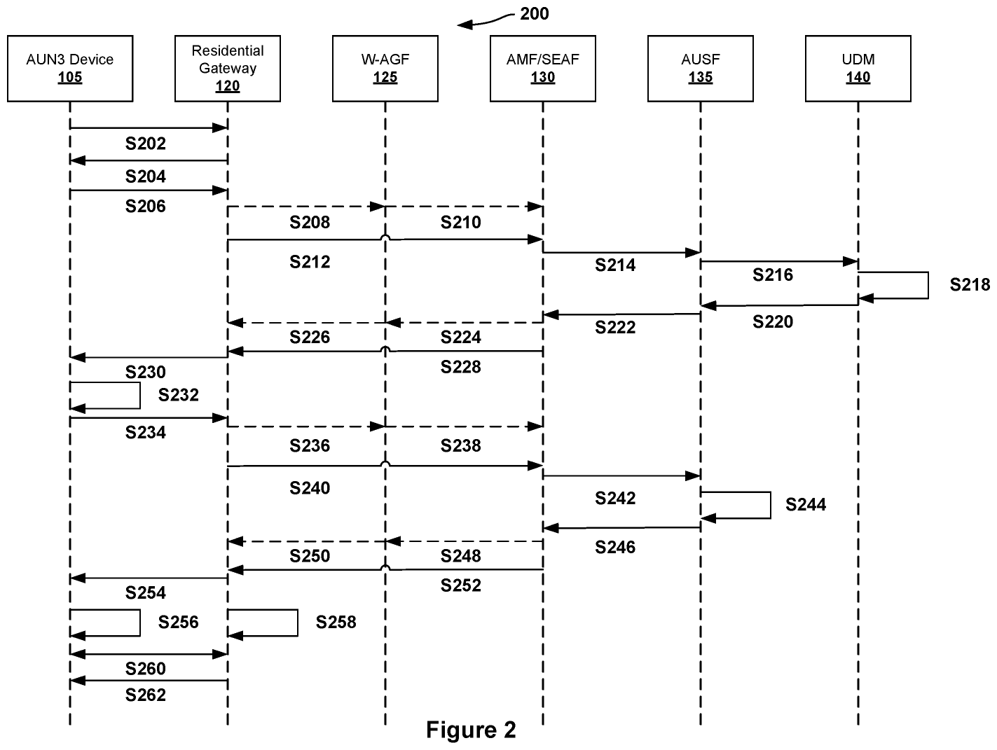

FIG. 2 is a timing diagram of a process 200 for authentication of non-3GPP devices 105 behind a residential gateway (RG) 120 using the system 100 (all shown in FIG. 1). In the exemplary embodiment, process 200 begins at step S202, in which the AUN3 device 105 initiates a layer 2 connection with the RG 120 (5G-RG or FN-RG) either via Ethernet or Wi-Fi. In some embodiments, if the layer 2 connection is based on Ethernet, steps S256 through S260 are skipped. In other embodiments, if the layer 2 connection is based on Ethernet, steps S234 through S240 are skipped.

In step S204, the RG 120 (5G-RG or FN-RG) initiates the EAP authentication procedure by transmitting an EAP request/Identity to the AUN3 device 105 in a layer 2 frame (e.g., EAPOL—Extensible Authentication Protocol over LAN). In Step S206, the AUN3 device 105 transmits back an EAP response/Identity message including its Network Access Identifier (NAI) in the form of username @realm. In some embodiments, the username part of the NAI may be encrypted if the AUN3 device 105 supports SUPI (Subscription Permanent Identifier) protection or privacy. In other embodiments, the AUN3 device 105 transmits the Subscription Concealed Identifier (SUCI) in the EAP response/identity if the AUN3 device 105 supports SUPI privacy.

Steps S208 and 210 are optional in some embodiments. If the RG 120 is an FN-RG (Fixed Network Residential Gateway) 120, then in step S208 the FN-RG 120 transmits to the W-AGF 125 an Authentication and Authorization (AAA) message including the NAI of the AUN3 device 105. The W-AGF 125 constructs a Subscription Concealed Identifier (SUCI) from the NAI-based SUPI using a NULL scheme. In step S210, the W-AGF 125 transmits a NAS (Non-Access Stratum) Registration Request message to the AMF 130, including the SUCI and the AUN3 device indicator.

If the RG 120 is a 5G-RG 120, then in step S212 the 5G-RG 120 constructs a SUCI using NULL scheme from the NAI-based SUPI of the AUN3 device 105 if received in step S206. The 5G-RG 120 transmits a NAS Registration Request message to the AMF 130, including the SUCI of the AUN3 device 105 and the AUN3 device indicator.

In step S214, the AMF/SEAF 130 selects the AUSF 135 based on the SUCI in the received registration request and the AMF/SEAF 130 transmits to the AUSF a Nausf_UEAuthentication_Authenticate Request message, including the SUCI of the AUN3 device 105 and the AUN3 device indicator. In step S216, the AUSF 135 transmits to the UDM 140 a Nudm_UEAuthentication_Get Request message, including the SUCI of the AUN3 device 105 and the AUN3 device indicator.

Upon reception of the Nudm_UEAuthentication_Get Request, in step S218, the UDM 140 invokes the SIDF (Subscription Identifier De-Concealing Function) to map the SUCI to the SUPI and select an authentication method (such as EAP-AKA′) based on the SUPI. When the “username” part of the SUPI is “anonymous” or omitted, the UDM 140 may select an authentication method based on the “realm” part of the SUPI, the AUN3 device indicator, a combination of the “realm” part and the AUN3 device indicator, or the UDM local policy. When the authentication method (such as EAP-AKA′) is selected, the UDM/ARPF (Authentication Credential Repository and Processing Function) 140 generates an authentication vector using the Access Network Identity as the KDF (key derivative function) input parameter.

In step S220, the UDM 140 transmits to the AUSF 135 a Nudm_UEAuthentication_Get Response message, including the EAP-AKA′ authentication vector (RAND, AUTN, XRES, CK′ and IK′) and the SUPI. The EAP-AKA′ authentication vector may include a random part RAND, an authenticator part AUTN used for authenticating the network to the AUN3 device 105, an expected response XRES, and other keys including IK′ for integrity check, CK′ for encryption etc. The AUSF 135 stores the XRES for future verification. According to the AUN3 subscription data, the UDM 140 also transmits the MSK (Master Session Key) indicator to the AUSF 135 to indicate that the AUN3 device 105 does not support the 5G key hierarchy. In step S222, the AUSF 135 transmits the EAP-Request/AKA′-Challenge message to the AMF/SEAF 130 in a Nausf_UEAuthentication_Authenticate Response message.

Steps S224 and 226 are optional in some embodiments. In steps S224 and S226, the AMF/SEAF 130 transmits the EAP-Request/AKA′-Challenge message to the RG 120 via the W-AGF 125 if the RG 120 is the FN-RG 120. In step S224, the EAP-Request/AKA′-Challenge message is carried in the NAS Authentication Response message from the AMF/SEAF 130 to the W-AGF. In step S226 the AAA message is transmitted from the W-AGF 125 to the RG 120.

If the RG 120 is the 5G-RG, in step S228, the AMF/SEAF 130 transmits the EAP-Request/AKA′-Challenge message to the RG 120 in the NAS Authentication Response message if the RG 120 is the 5G-RG 120.

In step S230, the RG 120 transmits the EAP-Request/AKA′-Challenge message to the AUN3 device 105 encapsulated in a layer 2 (L2) message. Upon receipt, the EAP-Request/AKA′-Challenge message, in step S232, the AUN3 device 105 verifies the message, generates the authentication response, and derives keys in accordance with RFC 5448. In step S234, the AUN3 device 105 transmits the EAP-Response/AKA′-Challenge message to the RG 120, encapsulated in a layer 2 message.

Steps S236 and S238 are optional in some embodiments. If the RG 120 is an FN-RG 120, then in step S236, the FN-RG 120 transmits to the W-AGF 125 the EAP-Response/AKA′-Challenge message in a AAA message. In step S238, the W-AGF S238 transmits to the AMF/SEAF 130 the EAP-Response/AKA′-Challenge message in an NAS Authentication Request message.

If the RG 120 is an 5G-RG 120, in step S240, the 5G-RG 120 transmits to the AMF/SEAF 130 the EAP-Response/AKA′-Challenge message in an NAS Authentication Request message. In step S242, the AMF/SEAF 130 transmits to the AUSF 135 the EAP-Response/AKA′-Challenge message in an Nausf_UEAuthentication_Authenticate Request message.

In step S244, the AUSF 135 verifies the AKA′-Challenge message in accordance with RFC 5448. If successful, the AUSF 135 generates the MSK (Master Session Key) in accordance with RFC 5448. Based on the AUN3 device indicator received in step S214, the AUSF 135 does not generate the intermediate key (K_{AUSF}).

In step S246, the AUSF 135 transmits to the AMF/SEAF 130 an Nausf_UEAuthentication_Authenticate Response message including the EAP-Success, the MSK, and the SUPI.

Steps S248 and S250 are optional in some embodiments. If the RG 120 is an FN-RG 120, then in step S248, the AMF/SEAF 130 transmits to the W-AGF 125 the EAP-Success message and the MSK in an Authentication Result message. In step S250, the W-AGF 125 transmits to the FN-RG 120 the EAP-Success message and the MSK in AAA message.

If the RG 120 is a 5G-RG 120, in step S252, the AMF/SEAF 130 transmits to the 5G-RG 120 the EAP-Success message and the MSK in an Authentication Result message. Based on the received MSK, the AMF 130 does not generate the 5G keys (K AMF). In some embodiments, the NAS security context is not required. NAS security between the AMF 130 and the 5G-RG 120 is established similar to unauthenticated emergency calls, i.e., with NULL encryption and NULL integrity protection. In these embodiments, the AMF/SEAF 130 transmits the NAS Security Mode Command to the 5G-RG 120 with NULL security algorithms. After receiving NAS Security Mode Complete message, the AMF/SEAF 130 transmits the MSK to the 5G-RG 120.

In step S254, the RG 120 transmits to the AUN3 device 105 the EAP-Success message in a layer 2 frame. If the layer 2 connection is over WLAN (IEEE 802.11), then in steps S256 and S258, the AUN3 device 105 and the RG 120 use the first 256-bit of the MSK as the PMK, from which the WLAN keys are derived. In steps S260, the AUN3 105 and the RG 120 perform four-way handshaking to establish a WLAN secure connection. In step S262, the RG 120 transmits the local IP configuration to the AUN3 device 105.

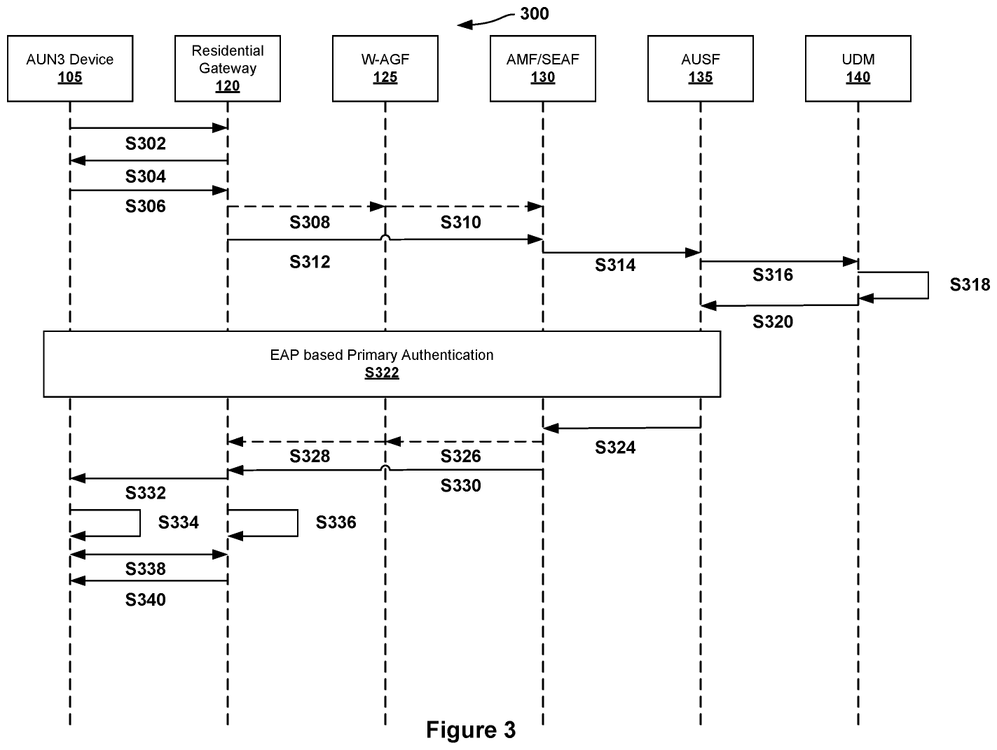

FIG. 3 is a timing diagram of a process 300 for authentication of non-3GPP devices behind a residential gateway using a key generating Extensible Authentication Protocol (EAP) method other than EAP-Authentication and Key Agreement′ using the system depicted in FIG. 1. This process 300 is an authentication procedure for AUN3 devices 105 behind a 5G-RG 120 in private networks or in isolated deployment scenarios (i.e., where roaming is not supported) using any key generating EAP method.

In process 300, steps S302-S316 are the same as steps S202-S216.

Upon reception of the Nudm_UEAuthentication_Get Request, in step S318, the UDM 140 invokes the SIDF (Subscription Identifier De-Concealing Function) to map the SUCI to the SUPI and select an authentication method (other than EAP-AKA′) based on the SUPI and the AUN3 device indicator. When the “username” part of the SUPI is “anonymous” or omitted, the UDM 140 may select an authentication method based on the “realm” part of the SUPI, the AUN3 device indicator, a combination of the “realm” part and the AUN3 device indicator, or the UDM local policy. When the authentication method (such as EAP-AKA′) is selected, the UDM/ARPF (Authentication Credential Repository and Processing Function) 140 generates an authentication vector using the Access Network Identity as the KDF (key derivative function) input parameter.

In step S320, the UDM 140 transmits to the AUSF 135 a Nudm_UEAuthentication_Get Response message, including SUPI and the EAP-AKA′ authentication vector (RAND, AUTN, XRES, CK′ and IK′) if EAP-AKA′ authentication is selected or the selected authentication method if another key generating key generating EAP method (e.g., EAP-TLS (Extensible Authentication Protocol-Transport Layer Security), EAP-TTLS (EAP-Tunneled TLS), etc.) is selected. Processing the EAP-AKA′ authentication vector is described above in step S220.

In step S322, the AUN3 device 105 and the AUSF 135 perform the selected EAP authentication method.

In process 300, steps S324-S340 are the same as steps S246-S262.

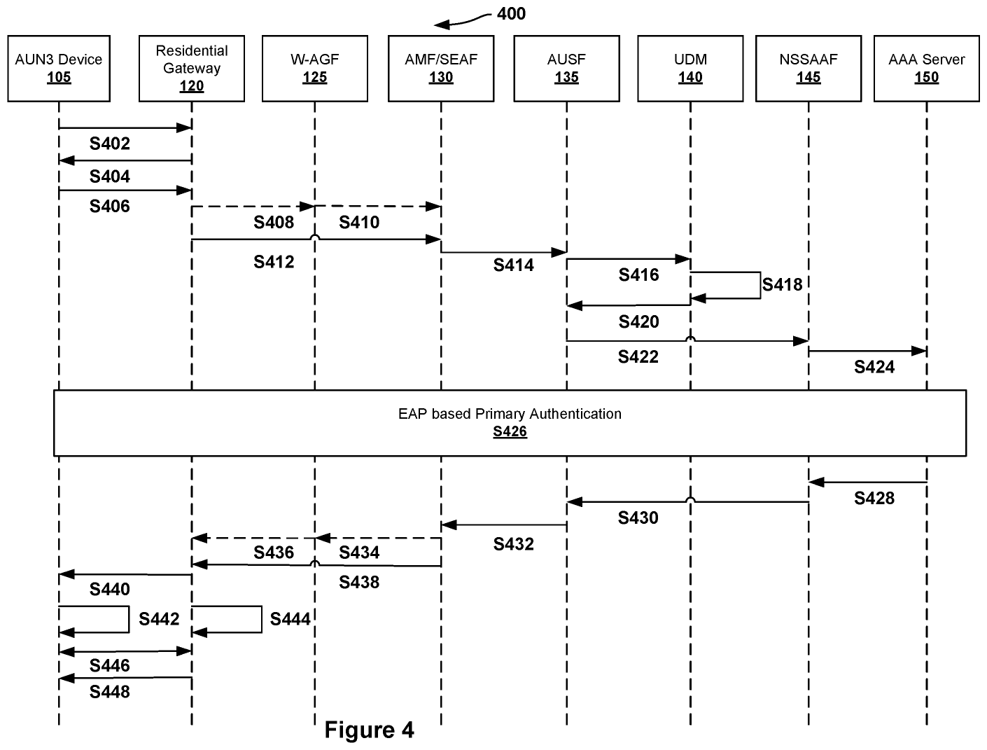

FIG. 4 is a timing diagram of a process 400 for authentication of non-3GPP devices 105 behind a residential gateway 120 using the Authentication and Authorization (AAA) server 150 (depicted in FIG. 1). This process 400 is an authentication procedure for AUN3 devices 105 by an AAA server 150 using a key generating EAP method.

In process 400, steps S402-S416 are the same as steps S202-S216.

Upon reception of the Nudm_UEAuthentication_Get Request, in step S418, the UDM 140 invokes the SIDF (Subscription Identifier De-Concealing Function) to map the SUCI to the SUPI and select an authentication method (other than EAP-AKA′) based on the SUPI and the AUN3 device indicator. In this embodiment, the UDM 140 decides to run primary authentication with an external entity based on subscription data. When the “username” part of the SUPI is “anonymous” or omitted, the UDM 140 may select an authentication method based on the “realm” part of the SUPI, the AUN3 device indicator, a combination of the “realm” part and the AUN3 device indicator, or the UDM local policy. If the anonymous SUPI is used, then it is in a NAI format.

In step S420, the UDM 140 transmits to the AUSF 135 a Nudm_UEAuthentication_Get Response message, including the SUPI and the selected authentication method (e.g., EAP-TLS, EAP-TTLS, etc.). In case that the UDM 140 received a SUCI in previous steps, the UDM 140 provides the AUSF 135 with the SUPI or anonymous SUPI and indicates to the AUSF 135 to run primary authentication with a AAA Server 150 in an external Credentials holder. When a Credentials Holder using AAA Server 150 is used for primary authentication, the AUSF 135 uses the MSK to derive intermediate key (K_{AUSF}). It is strongly recommended that the same credentials that are used for authentication between AUN3 device 105 and the 5GC 115 are not used for the authentication between the AUN3 device 105 and a non-5G network, assuming that 5GC 115 and non-5G network are in different security domains. In some embodiments, MSKs obtained from the non-5G network could be used to impersonate the 5GC 115 towards the AUN3.

Based on the indication from the UDM, in step S422, the AUSF selects a Network Slice Specific Authentication and Authorization Function (NSSAAF) 145 and initiate a Nnssaaf_AIWF_Authenticate service operation towards that NSSAAF 145.

In step S424, the NSSAAF 145 selects an AAA Server 150 based on the domain name corresponding to the realm part of the SUPI. The NSSAAF 145 performs related protocol conversion and relay EAP messages to the AAA Server 150.

In step S426, the AAA 150 and the AUN3 device 105 perform EAP authentication based on the selected authentication method. The AAA Server 150 acts as the EAP Server for the purpose of primary authentication. The EAP Identity received by the AAA Server 150 in the EAP-Response/Identity message in step S424 may contain an anonymized SUPI. In such cases, the AAA Server 150 uses the EAP-method specific EAP Identity request/response messages to obtain the AUN3 device identifier as part of the EAP authentication between the AUN3 device 105 and the AAA Server 150.

After successful authentication, in step S428, the AAA server 150 transmits an EAP Success message, the MSK, and the SUPI (i.e., the AUN3 identifier that is used for the successful EAP authentication) to the NSSAAF 145.

In step S430, the NSSAAF 145 transmits the EAP Success message, the MSK, and the SUPI to the AUSF 135 using the Nnssaaf_AIWF_Authenticate service operation response message. The SUPI received from the AAA server 150 is used when deriving 5G keys (e.g., K AMF) that requires SUPI as an input for the key derivation.

In case of onboarding or SUCI received in step S414 is not anonymous, the following is omitted. Otherwise, the AUSF 135 verifies that the SUPI corresponds to a valid subscription in the 5GC 115 by informing the UDM 140 about the authentication result for the received SUPI using a Nudm_UEAuthentication_ResultConfirmation service operation. The UDM 140 stores the authentication state for the SUPI and if there is not a subscription corresponding to the SUPI, the UDM 140 returns an error.

In process 400, steps S432-S448 are the same as steps S246-S262.

The computer-implemented methods discussed herein may include additional, fewer, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

The aspects described herein may be implemented as part of one or more computer components such as a client device and/or one or more back-end components, such as a cloud service server, for example. Furthermore, the aspects described herein may be implemented as part of computer network architecture and/or a cognitive computing architecture that facilitates communications between various other devices and/or components. Thus, the aspects described herein address and solve issues of a technical nature that are necessarily rooted in computer technology.

The improvements described herein may be achieved by performing one or more of the following steps: a) To be Completed upon Claim approval.

Furthermore, the embodiments described herein improve upon existing technologies, and improve the functionality of computers, by improving the security of provisioning devices and preventing their access to the network before they are fully provisioned. The present embodiments improve the speed, efficiency, and accuracy in which such calculations and processor analysis may be performed. Due to these improvements, the aspects address computer-related issues regarding efficiency over conventional techniques. Thus, the aspects also address computer related issues that are related to computer security, for example.

Accordingly, the innovative systems and methods described herein are of particular value within the realm of secure Internet communications. The present embodiments enable more reliable security during the device provisioning process, but without compromising data and speed. Furthermore, according to the disclosed techniques, user computer devices are better able to ensure the security of websites and other connected devices, and thereby protecting computer devices from malicious actors.

Exemplary embodiments of systems and methods for provisioning devices are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for authenticating a core network comprising:
a computing device comprising at least one processor in communication with at least one memory device, wherein the computing device is a part of the core network, and wherein the at least one memory device stores a plurality of instructions, which when executed by the at least one processor cause the at least one processor to:
receive, from a gateway, an authentication request message routed from a non-3GPP device;
transfer the authentication request message to a unified data management function;
select, by the unified data management function, an authentication method based upon the authentication request;
transmit an authentication challenge message to the non-3GPP device;
receive, from the gateway, the authentication response from the non-3GPP device;
verify the authentication response; and
transmit the authentication result to the non-3GPP device.

2. The system in accordance with claim 1, wherein the core network is a 5G core network.

3. The system in accordance with claim 1, wherein the selected authentication method is the Extensible Authentication Protocol Authentication and Key Agreement (EAP-AKA′), and wherein the instructions further cause the at least one processor to generate, by the unified data management function, an EAP-AKA′ authentication vector based upon the authentication request.

4. The system in accordance with claim 3, wherein the instructions further cause the at least one processor to:
store at least a portion of the authentication vector prior to transmitting the authentication challenge message; and
verify the authentication response based upon the stored portion of the authentication vector.

5. The system in accordance with claim 4, wherein the at least a portion of the authentication vector includes an expected response (XRES).

6. The system in accordance with claim 3, wherein the instructions further cause the at least one processor to generate the authentication vector using an Access Network Identity as an KDF (key derivative function) input parameter.

7. The system in accordance with claim 1, wherein the instructions further cause the at least one processor to transmit, by the unified data management function, an master session key (MSK) to indicate that the non-3GPP device does not support a 5G key hierarchy.

8. The system in accordance with claim 1, wherein the access request message includes at least one of a Subscription Permanent Identifier (SUPI) or a Subscription Concealed Identifier (SUCI) for the non-3GPP device.

9. The system in accordance with claim 8, wherein the instructions further cause the at least one processor to invokes, by the unified data management function, a SIDF (Subscription Identifier De-Concealing Function) to map the SUCI to the SUPI to select an authentication method (such as EAP-AKA′) based on the SUPI.

10. The system in accordance with claim 8, wherein when the “username” part of the SUPI is “anonymous” or omitted, the instructions further cause the at least one processor to select the authentication method based upon a “realm” part of the SUPI, an AUN3 device indicator, a combination of the “realm” part and the AUN3 device indicator, or a UDM local policy.

11. The system in accordance with claim 1 wherein the selected authentication method is one of EAP-TLS (Extensible Authentication Protocol-Transport Layer Security) or EAP-TTLS (EAP-Tunneled TLS).

12. The system in accordance with claim 11, wherein the instructions further cause the at least one processor to use an Authentication Server Function (AUSF) to perform the selected authentication method with the non-3GPP device.

13. The system in accordance with claim 1, wherein the gateway is a residential gateway.

14. A server for authenticating a core network, comprising:
a transceiver configured for operable communication with at least one gateway external to the core network;
a processor including a memory configured to store computer-executable instructions, which, when executed by the processor, cause the server to:
receive, from a gateway, an authentication request message routed from a non-3GPP device;
transfer the authentication request message to a unified data management function;
select, by the unified data management function, an authentication method based upon the authentication request;
transmit an authentication challenge message to the non-3GPP device;
receive, from the gateway, the authentication response from the non-3GPP device;
verify the authentication response; and
transmit the authentication result to the non-3GPP device.

15. The server in accordance with claim 14, wherein the core network is a 5G core network.

16. The server in accordance with claim 14, wherein the selected authentication method is the Extensible Authentication Protocol Authentication and Key Agreement (EAP-AKA′), and wherein the instructions further cause the at least one processor to generate, by the unified data management function, an EAP-AKA′ authentication vector based upon the authentication request.

17. The server in accordance with claim 16, wherein the instructions further cause the at least one processor to:
store at least a portion of the authentication vector prior to transmitting the authentication challenge message; and
verify the authentication response based upon the stored portion of the authentication vector.

18. The server in accordance with claim 17, wherein the at least a portion of the authentication vector includes an expected response (XRES).

19. The server in accordance with claim 16, wherein the instructions further cause the at least one processor to generate the authentication vector using an Access Network Identity as an KDF (key derivative function) input parameter.

20. The server in accordance with claim 14, wherein the instructions further cause the at least one processor to transmit, by the unified data management function, an master session key (MSK) to indicate that the non-3GPP device does not support a 5G key hierarchy.
